(19) United States
(12) Patent Application Publication
(10) Pub. No.: US 2009/0280032 A1
(43) Pub. Date: Nov. 12, 2009

(54) IMPROVED MULTI-WELL ASSAY PLATE

(76) Inventors: Willem Super, Emmen (NL); Cornelis Willem Roth, Emmen (NL); Marcus Petrus Waltherus van Loon, Lierop (NL); Robertus Petrus Maria van Hees, Middelbeers (NL)

Correspondence Address: HOFFMANN & BARON, LLP, 6900 JERICHO TURNPIKE, SYOSSET, NY, 11791, US

(21) Appl. No.: 12/305,235

(22) PCT Filed: Jun. 29, 2007
(86) PCT No.: PCT/NL2007/050321

§ 371 Date: Jun. 10, 2009

(30) Foreign Application Priority Data
Jun. 30, 2006 (EP) 06076343.0

(51) Int. Cl. B01L 3/00

(52) U.S. Cl. 422/99

(57) ABSTRACT

The invention relates to the field of analytical chemistry, in particular to multi-well assay plates having a unique flatness for use in high throughput (bio)chemical and biological assays which rely on luminescence detection. Provided is a multi-well assay plate a top layer including walls defining a plurality of adjacent sample wells for receiving assay samples, and a bottom layer defining the bottom of the wells, having a bottom surface facing away from the wells and wherein said bottom surface is provided with a grid structure forming a plurality of mock wells at the plate bottom, characterized in that the total volume of the mock wells is less than the total volume of the sample wells.

### FIELD OF THE INVENTION

The invention relates to the field of analytical chemistry, in particular to multi-well assay plates for use in high throughput (bio)chemical and biological assays which rely on luminescence detection.

### BACKGROUND OF THE INVENTION

Numerous methods and systems have been developed for conducting chemical, biochemical and/or biological assays. These methods and systems are essential in a variety of applications including medical diagnostics, food and beverage testing, environmental monitoring, manufacturing quality control, drug discovery and basic scientific research. Depending on the application, it is desirable that assay methods and detection systems have one or more of the following characteristics: i) high throughput, ii) high, sensitivity, iii) large dynamic range, iv) high precision and/or accuracy, v) low cost, vi) low consumption of reagents, vii) compatibility with existing instrumentation for sample handling and processing, viii) short time to result, ix) insensitivity to interferents and complex sample matrices and x) uncomplicated format. There is substantial value to new assay methods and to objects/systems for use in such methods that incorporate improvements in these characteristics or in other performance parameters.

Typically, samples and reagents are stored, processed and/or analyzed in multi-well assay plates (also known as multi-well test plates, microplates or microtiter plates). Multi-well assay plates can take a variety of forms, sizes and shapes. For convenience, some standards have appeared for some instrumentation used to process samples for high throughput assays. Multi-well assay plates are typically made in standard sizes and shapes and having standard arrangements of wells. Some well established arrangements of wells include those found on 96-well plates (12×8 array of wells), 384-well plates (24×16 array of wells) and 1536-well plate (48×32 array of wells). The Society for Biomolecular Screening (SBS) has published recommended microplate specifications for a variety of plate formats (see, http://www.sbsonline.org). For example, SBS-standardized plates have the standardized dimensions of 14.35 mm in height, 85.48 mm in width and 127.76 mm in length.

Assays carried out in standardized plate formats can take advantage of readily available equipment for storing and moving these plates as well as readily available (robot) equipment for rapidly dispensing liquids in and out of the plates. A variety of instrumentation is commercially available for rapidly measuring a signal, such as radioactivity, fluorescence, chemiluminescence, and optical absorbance, in or from the wells of a plate.

To ensure that the detection of signals in or from the wells of a plate, e.g. radioactivity, fluorescence, chemiluminescence and/or optical absorbance, can take place with high precision and accuracy, the overall “flatness” of the plate is of great importance. Any deviation from an optimal flatness will result in decreased accuracy of detection and reduced data quality. Also, it can cause mishandling problems in automated environments. It is the flatness of the assay well bottoms, in particular the inter-well flatness, that is critical for use with optical imaging devices, e.g. a CCD-imager, and other types of automated equipment. Thus, one of the current challenges in the field of microplate design is to improve the flatness of a multi-well assay plate, especially that of flat bottom well plates. The plate flatness, sometimes also referred to as bottom flatness, can be defined as the range between which the distance from the well bottoms to a support surface differs. For instance, a 96-well plate having a flatness of less than 300 μm indicates that the well bottoms are within a distance of maximally 300 μm of each other.

Some types of known flat-bottom 1536-well or 3456-well formats that are optimized for bottom-reading microplates readers and cell culture applications consist of a molded frame comprising walls which define sample wells. The bottom of the wells is formed by an unpigmented sheet with a thickness of 100 μm to provide a flat (within 250-300 μm) window for optical measurements of each well. A drawback of this type of plate is that it consists of two components (frame and sheet) and that it cannot be manufactured as a unitary piece. Instead, an injection molded frame needs to be assembled with the sheet forming the well bottoms. Furthermore, a plate flatness of 250-300 μm across wells is often not sufficient to obtain highly accurate measurements from the wells.

Also available is a two-part plate having a transparent bottom (see e.g. US2002/002219). Therein, the bottom of the wells is made of an inorganic material, in particular glass. The plate is manufactured by contacting an upper plate having open-ended wells made from a polymeric material containing a silane and infrared absorbing particle with a substantially flat glass sheet lower plate. By heating the upper plate using infrared welding technology, the molten upper plate polymer wets the lower glass plate such that the upper and lower plate are covalently bonded upon cooling. Whereas the plates display a good flatness across individual wells and across the entire plate, their material and method of manufacture is expensive and time consuming.

### SUMMARY

In an attempt to further improve multi-well assay plate performance and data quality, it is an object of the present teachings to provide a multi-well test plate having an improved well bottom flatness compared to other multi-well assay plates. In particular, it is an aim to provide a high density, SBS-standardized multi-well assay plate having an inter-well bottom flatness within approximately 150 μm, preferably within approximately 100 μm, which may be produced cost-effectively, for example, by injection molding as a unitary piece.

These goals are met by a surprising finding that a unique flatness both across individual wells and across the entire plate can be achieved by providing the bottom surface of a multi-well assay plate with multiple shallow “mock” wells. The present teachings therefore provide a multi-well assay plate comprising a top layer including walls defining a plurality of adjacent sample wells for receiving assay samples, a bottom layer defining the bottom of the wells, having a bottom surface facing away from the wells, characterized in that said bottom surface is provided with a plurality of ribs defining a plurality of adjacent mock wells, wherein the total volume of the mock wells is smaller than that of the sample wells

Also provided is a method for producing the plate. A further aspect relates to the use of the plate for the storage and/or assaying of test samples.

### BRIEF DESCRIPTION OF THE DRAWINGS

FIG. 1A shows a perspective view of a multi-well assay plate according to the invention. FIG. 1B shows a perspective bottom view of the multi-well assay plate shown in FIG. 1A, and FIG. 1C shows a side view in section of the multi-well assay plate shown in FIG. 1A.

### DETAILED DESCRIPTION OF THE INVENTION

The process of injection molding, which is a typical method for making multi-well plates, produces internal forces in the product. These internal forces tend to warp the plate and reduce the plate flatness. The forces, and thus the warping of the well plate, depend on many factors such as the injection pressure, position of the injection points in the plate, temperature of the mold, temperature of the plastic, and the design of the multi-well assay plate. The warping or bending of the plate may occur in many forms and patterns. For example, the warping may occur especially near the sides of the bottom surface or only on the middle, and the plate may warp in a wave pattern or in a convex or concave form.

Without wishing to be bound to any theory, it is believed that the mock wells on the bottom side of a multi-well assay plate according to the present teachings compensate for internal forces within the assay plate, which tend to bend or warp it. As a result, deformation of the well bottoms during their manufacture is reduced. It was surprisingly found that it is especially advantageous that the volume of the mock wells is smaller than that of the assay wells in view of injection moulding of the plate. Molds are typically constructed from hardened steel, pre-hardened steel, aluminium, and/or beryllium-copper alloy. Considerable thought is put into the design of molded parts and their molds, to ensure among others that the parts will not be trapped in the mold. Molds separate into at least two halves (called the core and the cavity) to permit the part to be extracted. Pins are the most popular method of removal from the core, but air ejection, and stripper plates can also be used depending on the application. Most ejection plates are found on the moving half of the mold, but they can be placed on the fixed half. The shallow mock wells having a smaller volume than the sample wells allow for an easy removal of moving half from the plate, while a unique overall plate flatness is obtained.

According to the invention, the total volume of the mock wells is less than 100%, preferably less than 80% more preferably less than 60%, most preferably less than 50% of the total volume of the assay wells.

This is in marked contrast to the assay plates disclosed in US2005/0106074. Therein, it is taught that the total volume of the “lightening portions” at the bottom of the plate must be essentially equal to the total volume of the assay wells to prevent warping of the plate. Furthermore, US2005/0106074 does not disclose an SBS-standardized plate with an overall plate flatness of less than 200 μm.

In one embodiment, a multi-well assay plate according to the invention comprising a shallow mock well structure at the bottom surface of the layer forming the bottom of the wells has a well bottom flatness of up to approximately 200 μm, preferably up to approximately 150 μm, more preferably up to approximately 100 μm. As shown herein, SBS-standardized multiwell plates are provided having a well bottom flatness of approximately 80 μm or even less. Multi-well assay plates, especially those that meet the SBS criteria, having such a unique well bottom flatness have not been disclosed before art.

It can be understood that other embodiments of microwell plates can exist without departing from the scope of the present teachings. For example, the illustrated embodiments use rectangular wells in a rectangular configuration, although such choices are merely arbitrary and other selections can be made within the scope of the invention.

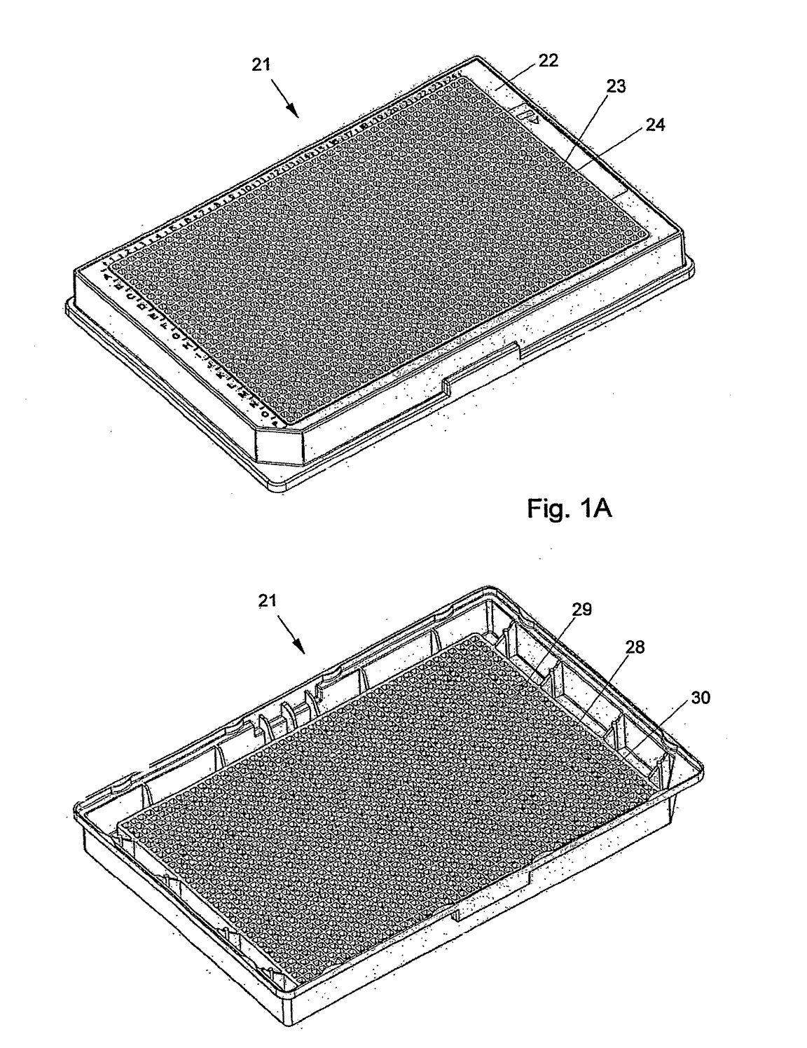

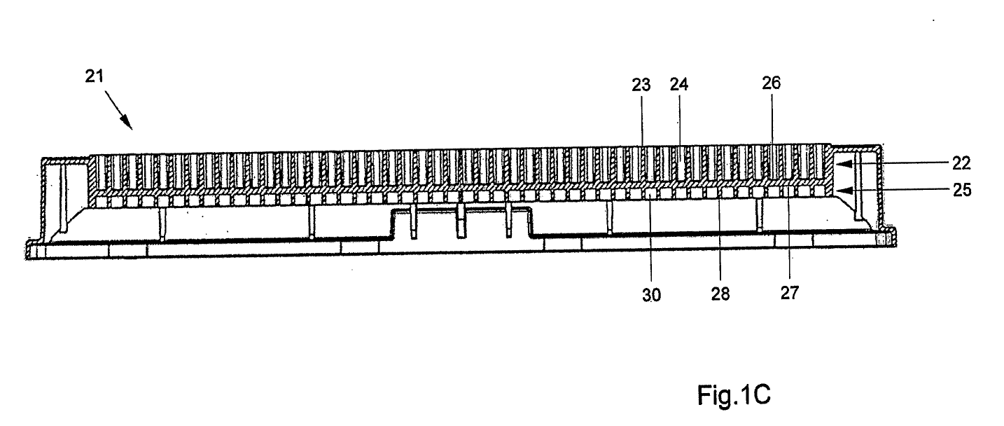

With reference to FIG. 1A-1C, a multi-well assay plate 21 is provided, comprising a top layer 22 including walls 23 defining a plurality of adjacent sample wells 24 for receiving assay samples. A bottom layer 25 of the assay plate defines the bottom of the wells 24, its top surface being the bottom surface 26 of the wells 24. The bottom layer 25 has a bottom surface 27 facing away from the wells 24. The bottom surface 27 of the bottom layer is provided with multiple parallel, straight ribs 28 crossing each other to form a bottom grid structure 29 with ribs 28 running e.g. perpendicular to each other in two directions, as is best shown in FIG. 1B. Thus a multi-well plate 21 is provided comprising at its bottom surface 27 multiple ribs 28 forming a bottom grid structure 29 that mirrors the grid structure formed by the walls 23 in the top layer 22, thereby forming a plurality of “mock wells” 30 at the plate bottom. Preferably, the number of mock wells 30 is equal to the number of assay wells 24. For example, provided is a 1536-well plate 21 comprising at its bottom surface 27 1536 mock wells, preferably in line with the assay wells 24 present in the top layer 22. In other words, it may be especially advantageous if, when seen in a side view in section as is shown in FIG. 1C, the walls 23 defining the wells 24 on the top side of the bottom layer 25 seem to extend on the opposite side of the bottom layer 25 to form the ribs 28 defining the mock wells 30.

Note that the volume of a mock well is smaller than that of a sample well to facilitate release of the plate from the mold.

To provide sufficient compensation for the warping forces in the top layer of the plate, it is preferred that the height of the ribs defining the mock wells is preferably at least approximately 10%, more preferably at least approximately 15%, most preferably at least approximately 20% of the height of the walls defining the sample wells. For example, in one embodiment a multi-well plate comprises a top layer with walls of approximately 4 to 5 mm in height defining sample wells and a bottom surface provided with ribs of approximately 1.5 to 2 mm in height. The height of the ribs is preferably less than approximately 80%, more preferably less than approximately 70%, most preferably less than approximately 50% of the height of the walls. The width is preferably, but not limited to being, equal to that of the walls defining the sample wells.

In a further aspect, the ribs on the bottom surface of the bottom layer defining the mock wells are positioned under at least some of the walls of the top layer defining the sample wells while there are no ribs under the well bottom areas. Thus, in one embodiment the sample wells are arranged at the same intervals as those of the mock wells, said sample wells and said mocks wells furthermore being arranged to be symmetrical with respect to the bottom layer (see FIG. 1C). This provides a good compensation of the warping forces that may occur in the top layer, whereas sink marks in the bottom surfaces of the wells are avoided.

The mock wells at the bottom surface of the plate do not need to be an exact copy of the wells in the top layer of the well plate for mirroring the grid structure formed by the walls. For example, while the assay wells may have a circular circumference, the mock wells may have an angular circumference, also, where the corner between the walls and the bottom of the assay wells is chamfered to prevent liquids from creeping up the walls, this is not needed in the mock wells.

Furthermore, the assay plate may, when standing on a support platform, at least partially rest on the ribs.

From the foregoing, it will be clear to the skilled person, that within the framework of invention as set forth in the claims also many variations other than the examples described above are conceivable. For instance, the well plates may have any number of wells of any size or shape, arranged in any pattern or configuration, and be composed of a variety of different materials.

The assay wells of the plate are typically arrayed in a planar pattern to provide high-density, low-volume formats for automated liquid handling and assay systems capable of manipulating and assaying in parallel multiple small volume samples. The wells can be any volume or depth. Wells can be made in any cross-sectional shape (in plan view) including square, sheer vertical walls or conical walls. It is preferred that the cross-sections of the mock wells and the assay wells are essentially the same whereas the assay wells have a greater depth. Preferred wells are those having a circular or square opening, the diameter or length of a side of which is in the range of 1.0 to 2.0 mm. For example, provided herein is an assay plate comprising assay wells with a square opening, the sides of the opening being about 1.7 mm and an equal number of mock wells having the same square cross-section.

The plate may have a thickness in a range between approximately 0.5 mm and approximately 15 mm. Preferred embodiments of the invention are multi-well assay plates that use industry standard (e.g. SBS) multi-well plate formats for the number, size, shape and configuration of the plate and wells. A plate having a high-density planar array of sample wells in which dimensions of the wells and their positions on the array are scaled according to the proposed standards enable compatibility with the wide range of automated instrumentation designed to be compliant with multi-well platforms manufactured to the proposed standards. Examples of standard formats include 8×12 (96)-, 16×24 (384)-, 32×84 (1536)-, and 48×72 (3456)-well assay plates, with the wells configured in two-dimensional arrays. In a

preferred embodiment, a plate of the invention is a 1536- or 3456-well assay plate having footprint dimensions inline with the proposed SBS industry standard. This guarantees compatibility with all microplate-based instrumentation.

An issue that arises when dealing with assay plates comprising a high to very high number of small volume assay wells is sample evaporation, e.g., during storage, manipulation and/or analysis of the sample. The ratio of surface area to volume of a well of a typical 3456-well plate is about four times that of a 96-well plate. Since evaporation rate is directly proportional to exposed surface area, a 1 mm diameter well of a 3456-well plate would lose about 40% of its volume in the same time that a 7 mm well of a 96-well plate would lose 10%. Furthermore, small wells at the plate edges evaporate significantly faster than small wells at the interior of the assay plate, which can be detrimental to an experiment being run or to a chemical being stored in a plate. In order to at least partially overcome sample evaporation, a multi-well assay plate of the invention may comprise multiple evaporation control wells or “dummy” wells in the top layer of the plate. The teaching of U.S. Patent application 60/493,415 and PCT application PCT/US04/13516 related thereto can be used for the design of a plate comprising dummy wells. For example, the dummy wells are preferably also defined by wall disposed within the top layer. The dummy wells preferably form a ring around the array of sample wells. The depth of the dummy wells may differ from that of the sample wells. Thus, in an embodiment the plate also incorporates in the top layer an arrangement of wells not used for assay or chemical storage, but which can be filled with an assay liquid or storage solvent to mitigate evaporation of liquid in the wells used for assay or storage. According to the invention, the dummy wells are preferably also mirrored on the bottom surface.

In addition, the plate may contain additional useful features such as indentations for the accommodation of lids to maintain a closed environment surrounding the liquid contents of the wells, and/or markings to enable optically guided automated alignment of the plate with instrumentation. The microplates may contain a ‘pinch bar’ to facilitate manual and automated processing using robotized systems. Moreover, an increased nesting tolerances and ribbed underside can avoid stacker jams in HTS protocols, even with sealed microplates.

A further aspect relates to the manufacture of a multi-well assay plate of the invention. The plate can be easily formed as a unitary piece by injection molding according to standard procedures.

Preferably, the plate is formed from a single material that combines desirable optical, mechanical, and chemical inertness and resistance properties so that the same plate can be inexpensively manufactured and then utilized for the various different tasks of (automated) chemical, biochemical and biological assays.

Many types of polymers can be used for the manufacture of a multi-well plate as provided herein. The plate can be made from rigid thermoplastic material such as polystyrene (PS), polyethylene (PE) or polypropylene (PP). Preferably, the material of choice has a low mold shrinkage (e.g., less than about 0.4%) and low melt viscosity to allow manufacture of small (e.g. less than about 1 mm) features on the plate.

In an exemplary embodiment, a suitable polymer or mixture of polymers is injected into a mold built of (e.g. stainless) steel using a single or a a number of injection gates placed on the outer walls of the plate. The mold typically has polished core pins to create the sample wells and a stripper plate to remove the part from the core pins after it solidifies.

A multi-well plate can be made from more than one material, for example by applying two component injection molding during the fabrication. According to one preferred embodiment, the material comprises polystyrene blended with High Impact Polystyrene (HIPS) to reduce the brittleness of the material. Preferably, between approximately 4 and approximately 16 wt % HIPS is blended with the polystyrene, more preferably between about 8 and about 12 wt %. The plate is preferably made of an inexpensive material that is generally impervious to reagents typically encountered in fluorescence (e.g. ECL) measurements, resistant to the absorption of biomolecules, and can withstand modest levels of light and heat. Advantageously, the plate material is impervious to organic solvents typically used to dissolve chemical libraries for high throughput screening.

In a specific aspect, the multi-well plate of the invention is made of a material that exhibits low auto-fluorescence when illuminated with screening wavelengths, in the UV or visible range. Such a plate is particularly suitable for fluorescence and other spectrometric measurements due to the low intrinsic fluorescence of the well bottom. Preferably, the material exhibits autofluorescence at screening wavelengths below 5%, more preferably below 4%, and further substantially 3% or less.

According to one embodiment, a material for a multi-well plate is or includes cyclo-olefin copolymer (COC). Other suitable materials include styrene acrylonitrile (SAN) and Barex® resins.

A microplate provided herein can be transparent (clear) or it can be non-transparent. Colored plates can be made using colorants known in the art. Typical colorants include TiO₂ (white), Carbon Black, UV-absorbers (Yellow). The person skilled in the art will recognize that, depending on the desired properties of the plate, other types of additives may be included. In one embodiment, a scintillant is incorporated in the plastic material that is used for injection molding the plate as a unitary piece.

A further aspect of the invention relates to the use of a multi-well assay plate as provided herein, for example in methods for assaying multiple samples and/or the storage of samples.

The multi-well plates can be used in automated and integrated systems in which small volumes of stored chemical compounds are transferred from one multi-well platform used for storage purposes to another multi-well platform used to perform assays for chemical or biological activities of the same compounds, particularly automated screening of low-volume samples for new drugs, agrochemicals, food additives and cosmetics.

In one embodiment, a method is provided for performing an assay, e.g. a (bio)chemical or biological assay using a plate of the invention. Said method may comprise the steps of employing at least some of the sample wells for performing the assay and analyzing data from measurements performed on the wells. Because of their unprecedented plate flatness, plates of the invention are particularly suitable for highly accurate luminescence, e.g. fluorescence, detection.

Also provided is a method for measuring luminescence from a multi-well assay plate, comprising forming an image of luminescence generated in at least one essay well of a plate according to the invention. Examples of luminescence include fluorescence, bioluminescence and phosphorescence.

Said methods may involve the use of an automated plate reader, particular an automated optical imaging device. In a preferred embodiment, a plate of the invention is used in an assay method comprising detection of a fluorescence signal generated in at least one of the wells using an automated CCD imaging system.

Providing a more uniform and consistent well bottom elevation minimizes or even avoids the need to refocus the imaging system because the distance between CCD camera and well bottom surface is essentially the same from well to well.

For example, the PerkinElmer ViewLux™ is an ultrahigh throughput microplate CCD-imager for high sensitivity and fast measurement of light from fluorescence polarization (FP), fluorescence intensity, time-resolved fluorescence (TRF), luminescence and absorbance assays. The detector is a Peltier-cooled CCD camera coupled to an optimized telecentric optical lens. The camera is a back illuminated CCD operating at −100° Celsius. For epi-fluorescence excitation there is an extremely powerful array of flash-lamps together with high-quality optics. The instrument supports both robot loading and batch mode operation. Up to 64 plates can be loaded for unattended operation. Users can alternate between batch and robot loading according to needs. Because the instrument reads entire plates in one exposure, throughput is not affected by plate density. A throughput of >200,000 samples per hour under continuous operation can be achieved using 1536-well plates reading fluorescence intensity. For fluorescence polarization assays, including plate movement and data handling, typical processing times are less than 90 seconds per plate.

### EXAMPLE

One batch of 1536-well plates was prepared by injection molding of polystyrene comprising a white pigment. Injection molding was performed using an Arburg S 220/270 injection molding machine. The temperature of the mold halve forming the bottom of the plate was set at 70° C., whereas the mold halve forming the top of the plate was set at 30° C.

The mold design ensured that the dimensions of the plate satisfied the SBS standard for microplates (14.35 mm in height, 85.48 mm in width and 127.76 mm in length). Sample well volume was approximately 12 μl. The walls defining the sample wells were 4.8 mm in height. The length of a side of the square opening of the sample wells was 1.7 mm. The inside of the sample well walls was polished according to ISO 1302 N-3 (Ra=0.1). The ground surfaces of the sample wells were polished according to ISO 1302 N-1 (Ra=0.025). The bottom of the plate was provided with 1536 mock wells having similar square openings. The ribs defining the mock wells had a height of 1.6 mm. The volume of one mock well was about 4 μl, i.e. approximately one third of the volume of a sample well. The plates could be stacked onto each other with a stack height of 12 mm.

Five plates were selected randomly for analysis of the flatness of the plates. The position of the bottom surface of seventy randomly selected individual assay wells was determined relative to the ground plate. All sample wells were within a tolerance zone of 100 μm. The following average values were observed for overall plate flatness:
Plate 1: 82 μm
Plate 2: 79 μm
Plate 3: 80 μm
Plate 4: 82 μm
Plate 5: 79 μm

1. A multi-well assay plate comprising:
a top layer including walls defining a plurality of adjacent sample wells for receiving assay samples, and
a bottom layer defining the bottom of the wells, having a bottom surface facing away from the wells and wherein said bottom surface is provided with a grid structure forming a plurality of mock wells at the plate bottom,
characterized in that the total volume of the mock wells is less than the total volume of the sample wells.

2. Assay plate according to claim 1, wherein the mock wells have a depth of less than 100%, preferably less than 80% more preferably less than 60%, most preferably less than 50% of said sample wells.

3. Assay plate according to claim 1, having a plate flatness of less than approximately 200 μm.

4. Assay plate according to claim 3, having a plate flatness of less than approximately 100 μm, more preferably less than approximately 80 μm.

5. Assay plate according to claim 1, wherein the number of mock wells equals the number of sample wells.

6. Assay plate according to claim 1, being a 1536-well or 3456-well plate meeting the SBS Microplate specifications.

7. Assay plate according to claim 1, furthermore comprising, in addition to the sample wells, a plurality of dummy wells in the top plate which dummy wells can be filled with a liquid.

8. Assay plate according to claim 1, made as a unitary piece, preferably by injection molding.

9. Assay plate according to claim 1, wherein the plate is made from a transparent or non-transparent material, preferably made from a polymer selected from polystyrene (PS), polypropylene (PP), polyethylene (PE), styrene acrylonitrile (SAN) and cyclo-olefin copolymer (COC), or a combination thereof.

10. Assay plate according to claim 1, wherein the plate is made from a material of low auto-fluorescence.

11. Assay plate according to claim 8, wherein a scintillant is incorporated in the material of the plate.

12. Use of an assay plate according to claim 1 for assaying and/or storage of a sample.

13. A method for measuring luminescence from a multi-well assay plate, comprising forming an image of luminescence generated in at least one essay well of a plate according to claim 1, preferably using an automated plate reader.

14. Method according to claim 13, comprising the use of an optical imaging system, preferably a CCD-imaging system.
